(19) United States
(12) Patent Application Publication
(10) Pub. No.: US 2008/0110320 A1
(43) Pub. Date: May 15, 2008

(54) Matter for the all aluminum housing used for producing sound

(76) Inventor: Cheynetta L. Boone, Chesapeake, VA (US)

Correspondence Address: CHEYNETTA L. BOONE, 1096 CASCADE BLVD., CHESAPEAKE, VA, 23324, US

(21) Appl. No.: 11/598,274

(22) Filed: Nov. 13, 2006

(51) Int. Cl. G10D 13/08

(52) U.S. Cl. 84/380 R; 84/402

(57) ABSTRACT

The purpose for the all aluminum housing, it is used for producing sound out of aluminum. When the aluminum is used, to make an instrument—yes, the embodiment of the instrument is aluminum; which it makes the instrument lighter to hold, and it gives a distinguishing sound. A clean, clear, crisp and firm quality sound; no more waiting a year for your instrument to cure, or using your instrument till it cure, or heavy woods or heavy plastics. The reason for the all aluminum housing used for producing sound, and also having a use—for a speaker box to be made out of all aluminum, and not wood to make the speaker box lighter in your home or vehicle (when carrying around your speaker box in your vehicle). The purpose for the all aluminum housing, it's usage for producing sound, and it is ideal for a car back window surface lid. And, it is ideal for intercom boxes; and for a speaker frame for speakers.

### BRIEF SUMMARY OF THE INVENTION

The matter for the all aluminum housing used for producing sound out of aluminum, when the aluminum is uses to make instruments yes, the embodiment of the instruments is aluminum it makes the instrument lighter to hold, and give a distinguishing of a clean clear quality firm sound, no move waiting year for your instrument to cure, or using your instruments to it cure, or heavy woods, or heavy plastics.

The matter for the all aluminum housing used for producing sound, and, also having a uses for speaker box to be made out of all aluminum, and not wood to makes the speaker box lighter in home or in your vehicle when carrying around your speaker box in your vehicle. The matter for the all aluminum housing used for producing sound, and is idea for a car back window surface lid, and is idea for intercom boxs, and for a speaker fame for speakers.

I claim:

1. THE METTER FOR THE ALL ALUMINUM HOUSING USED FOR PRODUCING SOUND, to make the embodiment of the all aluminum instruments out of all aluminum and the opening closing into the embodiment of the all aluminum instrument and the separating of the all aluminum instrument, and the producing of the aluminum sound that comes for the embodiment of the all aluminum instrument when using the instrument, and the embodiment of the all aluminum instrument can be light or heavy or heavy and light together or thine or thick or thin or can be thick or thin together or can have a different kinds of metals added into the embodiment of the all aluminum instrument to make up the aluminum to uses inside the embodiment of the all aluminum instruments, and uses different kinds of colors inside of the aluminum embodiment of the instrument, and different colors together, inside of the embodiment of the all aluminum instruments and the instruments can be any instrument made out of all aluminum, and the idle of making the all aluminum, instruments out of all aluminum, and making the embodiment of the embodiment of the instrument all aluminum, and I claim all part that are need to the instruments embodiment, that is all aluminum, and the instrument can very, of different kinds of instrument and size can very, like drum stick, trumpets, cornets, pocket truumpeta, flugel horns, bartones, euphoniums, sousaphones tubas, saxophones, flutes and piccolos, oboes, bassoons moth pieces, orcbestral stringed instrments, violinns, cellos, percussinon, educational percussion, marching precussion, drum kits, world percussion, combo, clarinets, acoustic guitars, bass guitars, classical guitard, electric, guitars, and any kinds of accessories that goes to the instrument.

2. THE MATTER FOR THE ALUMINUM HOUSING USED FOR PRODUCING SOUND; To make speaker boxes out of all aluminum and the embodiment of the speaker boxes and the opening and closing into the embodiment of the all aluminum speaker boxes and the separating of the all aluminum speaker boxes on all side top and bottom of the embodiment of the all aluminum speaker boxes, and the the producing of the sound that comes for the embodiment of the all aluminum speaker boxes, and the embodiment of the all aluminum speaker boxes can be light or heavy or heavy and light together or thick or thin or can be thick or thin together or can have different kinds of metals added into the aluminum, to make up the aluminum to uses inside for the embodiment of the all aluminum speaker boxes, and can uses different kinds of colors inside of the all aluminum embodiment of the speaker boxes, when making and different colors, together inside of the embodiment of the all aluminum speaker boxes, the idle idle is the embodiment of the all aluminum speaker boxes can come in any shape or form, and, I claim any kind of all aluminum stew, to go into the all aluminum speaker boxes to hold the all aluminum speaker boxs together which all aluminum stew, and stew can very and colors and in shape and in size, to go to the embodiment of the all aluminum speaker boxes.

3. THE MATTER FOR THE ALL ALUMINUM HOUSING USED FOR PRODUCING SOUND, and, the making of the all aluminum surface lid out of all aluminum to hold the all aluminum speaker frame or a speaker, the surface lid that holds the all aluinum speaker frame can be msde to go on a speaker boxes or can be made to go inside of a car, or can be inclosed with all aluminum around the surface lid and can be made out of all aluminum around the lid, the surface lid is flat and can be mounted with all aluminum stew, and the I claim the all aluminum surface lid, and the all aluminum surface lid can be light or heary or thin or can have different kinds of metals added into the embodiment of the all surface lid to make up the aluminum to uses inside of the embodiment of the all aluminum surface lid, and the idle of the all aluminum surface lid,to hold all aluminum speaker frame, and the all aluminum surface lid and the all aluminum speaker frame can be made out different kinds of colors inside of the all aluminum to make up the all aluminum surface lid and the all aluminum speaker frame.
